(19) United States
(12) Patent Application Publication
(10) Pub. No.: US 2026/0061319 A1
(43) Pub. Date: Mar. 5, 2026

(54) Systems and Associated Methods for Artificial Intelligence (AI)-Based Generation of Filler Content for Video Game

(71) Applicant: Sony Interactive Entertainment Inc., Tokyo (JP)

(72) Inventors: Victoria Dorn, San Mateo, CA (US); David Henshaw, San Mateo, CA (US)

(21) Appl. No.: 18/821,951

(22) Filed: Aug. 30, 2024

(51) Int. Cl. A63F 13/60

(52) U.S. Cl. CPC A63F 13/60

(57) ABSTRACT

Methods are provided for automatically generating filler content for a video game. A first collection of game play state data of a video game is accessed. A first video game output corresponding to the first collection of game play state data is also accessed. A second collection of game play state data of the video game is also accessed. A second video game output corresponding to the second collection of game play state data is also accessed. An artificial intelligence (AI) system is executed to automatically generate video game filler content that fills a content gap between the first video game output and the second video game output in accordance with a target filler content specification. The AI system is configured to use the first collection of game play state data and the second collection of game play state data as inputs for generation of the video game filler content.

### BACKGROUND OF THE INVENTION

The video game industry has seen many changes over the years and has been trying to find ways to enhance the video game play experience for players and increase player engagement with the video games and/or online gaming systems, which ultimately leads to increased revenue for the video game developers and providers and the video game industry in general. It is within this context that implementations of the present disclosure arise.

### SUMMARY OF THE INVENTION

In an example embodiment, a method is disclosed for automatically generating filler content for a video game. The method includes accessing a first collection of game play state data of a video game. The method also includes accessing a first video game output corresponding to the first collection of game play state data. The method also includes accessing a second collection of game play state data of the video game. The method also includes accessing a second video game output corresponding to the second collection of game play state data. The method also includes executing an artificial intelligence (AI) system to automatically generate video game filler content that fills a content gap between the first video game output and the second video game output. The AI system is configured to use the first collection of game play state data and the second collection of game play state data as inputs for generation of the video game filler content.

In an example embodiment, a method is disclosed for automatically generating filler content for a video game. The method includes a first operation for executing a first AI engine to automatically generate a filler video clip that extends from an end of a first video clip to a beginning of a second video clip. The first video clip corresponds to a first collection of game play state data of a video game. The second video clip corresponding to a second collection of game play state data of the video game. The method includes a second operation for executing a second AI engine to automatically determine a degree of representation of a target filler video specification within the filler video clip. In response to the second operation determining that the degree of representation of the target filler video specification within the filler video clip is less than a video representation threshold value, the method proceeds with a third operation for executing a third AI engine to automatically generate an input for the first AI engine that drives the filler video clip toward the target filler video specification. The method includes repeating sequential performance of the first, second, and third operations until the second operation determines that the degree of representation of the target filler video specification within the filler video clip is greater than or equal to the video representation threshold value. In response to the second operation determining that the degree of representation of the target filler video specification within the filler video clip is greater than or equal to the video representation threshold value, the method proceeds with executing a fourth AI engine to automatically generate a filler audio clip that corresponds temporally and contextually with the filler video clip.

### BRIEF DESCRIPTION OF THE DRAWINGS

FIG. 1 shows an example of video game output as a function of time, in accordance with some embodiments.

FIG. 2 shows an example image of a first video clip at the end (time T1) of the first video game output as shown in FIG. 1.

FIG. 3 shows an example image of a second video clip at the beginning (time T2) of the second video game output as shown in FIG. 1.

FIG. 4 shows an example image of a filler video clip that is automatically generated by the AI-based methods and systems disclosed herein as part of filler content for filling the content gap as shown in FIG. 1 between the scene of FIG. 2 and the scene of FIG. 3.

FIG. 5 shows a system for automatically generating filler content for a video game, in accordance with some embodiments.

FIG. 6A shows a flowchart of a method for automatically generating filler content for a video game, in accordance with some embodiments.

FIG. 6B shows a flowchart of an optional extension of the method of FIG. 6A, in accordance with some embodiments.

FIG. 7A shows a flowchart of a method for automatically generating filler content for a video game, in accordance with some embodiments.

FIG. 7B shows a flowchart of an optional extension of the method of FIG. 7A, in accordance with some embodiments.

FIG. 8 shows various components of an example server device within a cloud-based computing system that can be used to implement aspects of the system of FIG. 5, and perform the methods of FIGS. 6A, 6B, 7A, and 7B, for AI-based generation of filler content for a video game, in accordance with some embodiments.

### DETAILED DESCRIPTION OF THE INVENTION

In the following description, numerous specific details are set forth in order to provide a thorough understanding of the present disclosure. It will be apparent, however, to one skilled in the art that embodiments of the present disclosure may be practiced without some or all of these specific details. In other instances, well known process operations have not been described in detail in order not to unnecessarily obscure the present disclosure.

Many modern computer applications, such as video games, virtual reality applications, augmented reality applications, virtual world applications, etc., include generation and output of video and audio. For ease of description, the term “video game” as used herein refers to any type of computer application in which video (and optionally audio) is generated and output to reflect interactive engagement of a user with the computer application, such as by way of providing video game controller inputs. For ease of description, the term “developer” as used herein refers to a real-world person that engages in developing the video game. The developer of the video game is challenged to create graphical scenes and interactive content within the video game that engages and entertains players of the video game in accordance with various development objectives. In various embodiments, the development objectives can include providing visual variety, promoting visual interest, attracting attention, conveying meaning, provoking emotion, inviting contemplation, stimulating user interaction with the video game, ensuring achievable player advancement within the video game, and ensuring sufficient player challenge within the video game, among many other development objectives. The video game may include various scenes, stages, and/or branches through which the player of the video game moves or progresses. The video game development process expends extensive financial and temporal resources on creating these various scenes, stages, and/or branches of the video game. However, it is often the case that content gaps exist in the video and audio output of the video game between the various scenes, stages, and/or branches through which the player of the video game moves or progresses. Also, many video games provide for recaps of video game play in the form of video clips and corresponding audio clips. It is often the case that content gaps exist with these recaps, such that the recaps appear more as a montage of different video clips and corresponding audio clips, as opposed to a more continuous rendering of video and/or audio content. Therefore, it is of interest to develop methods and systems to assist the developer of the video game with the automatic generation of filler content for the video game that can be used in place of the aforementioned content gaps in the video and/or audio output of the video game. To this end, various methods and systems are disclosed herein by which a video game developer can leverage artificial intelligence (AI) capabilities in assisting with automatic generation of filler content for the video game.

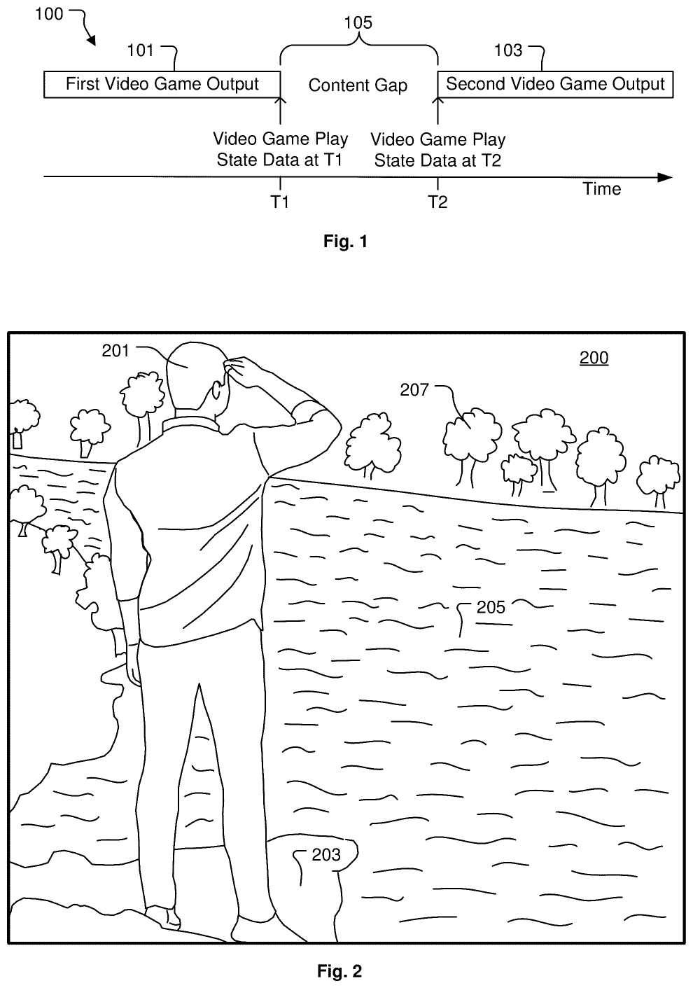

FIG. 1 shows an example of video game output as a function of time, in accordance with some embodiments. The video game output includes a first video game output 101 and a second video game output 103, with a content gap 105 existing between the first video game output 101 and the second video game output 103. The first video game output 101 includes a first video clip that ends at a time T1. In some embodiments, the first video game output 101 also includes a first audio clip that corresponds to the first video clip and that also ends at the time T1. The second video game output 103 includes a second video clip that begins at a time T2. In some embodiments, the second video game output 103 also includes a second audio clip that corresponds to the second video clip and that also begins at the time T2. The content gap 105 extends from the time T1 to the time T2. The content gap 105 corresponds to an absence of video and/or audio output of the video game.

The first video game output 101 reflects interactive play of the video game by one or more players of the video game. Video game play state data is continuously generated along the timeline corresponding to the first video game output 101. Therefore, a first collection of game play state data of the video game exists at the time T1. The second video game output 103 reflects interactive play of the video game by one or more players of the video game. Video game play state data is continuously generated along the timeline corresponding to the second video game output 103. Therefore, a second collection of game play state data of the video game exists at the time T2. The game play state data of the video game defines the state and/or condition of the video game at a particular point during play of the video game by one or more players, i.e., a snapshot of the video game play at a particular time. In some embodiments, the game play state data of the video game defines the state of game play of a particular player of the video game at a particular point in time. In some embodiments, game play state data of the video game includes user/player saved data that includes information that personalizes the video game for the particular player. For example, game play state data of the video game can include information associated with the particular player's character, so that the video game is rendered with a character that may be unique to the particular player at the particular point in the video game play, such as with regard to shape, look, clothing, weaponry, etc. In various embodiments, game play state data of the video game includes game characters, game objects, game object attributes, game attributes, game object state, graphic overlays, among any other data necessary to recreate the state of the video game at the particular point in time. Game play state data provides for regeneration of the gaming environment within the video game that existed at the particular point in time corresponding to the game play state data. In various embodiments, game play state data of the video game also includes the state of every device used for rendering the output of the video game, such as the states of the central processing unit (CPU), the graphics processing unit (GPU), the computer memory, the computer register values, the program counter value, the programmable direct memory access (DMA) state, the buffered data for the DMA, the audio processing chip state, the CD-ROM state, and/or any other device involved in generating the output of the video game. Also, in various embodiments, the game play state data of the video game identifies which parts of the executable code of the video game need to be loaded to execute the video game from the point in the video game corresponding to the game play state data.

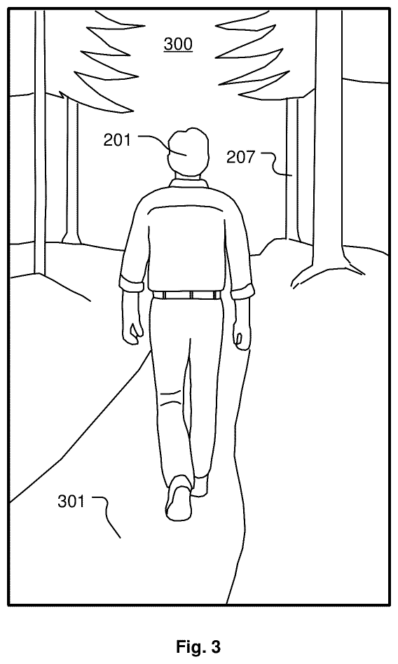

In some embodiments, the first video game output 101 and the second video game output 103 correspond to respective scenes within the video game. More specifically, the end of the first video game output 101 at time T1 corresponds to the end of a first scene within the video game, and the beginning of the second video game output 103 at time T2 corresponds to the beginning of a second scene within the video game. For various reasons, it is of interest to have filler content for the video game to fill the content gap 105. For example, in some embodiments, the first video game output 101 and the second video game output 103 are presented sequentially within a recap of play of the video game, but the content gap 105 introduces an undesirable abrupt transition from the first scene to the second scene in the recap of play of the video game. To illustrate this point, FIG. 2 shows an example image of a first video clip at the end (time T1) of the first video game output 101. Also, FIG. 3 shows an example image of a second video clip at the beginning (time T2) of the second video game output 103. FIG. 2 shows a scene 200 within the video game in which an avatar 201 (shown as a person) of a player has arrived at an edge of a cliff 203 overlooking a river 205 that has to be crossed to proceed to a forest 207 on the other side of the river 205. FIG. 3 shows a scene 300 within the video game in which the avatar 201 of the player has embarked on a path 301 leading into the forest 207. The implication in this example is that the avatar 201 somehow crossed the river 205 that was shown in FIG. 2. The content gap 105 in this example is the crossing of the river 205 by the avatar 201 to get from the end of the scene 200 depicted in FIG. 2 to the beginning of the scene 300 depicted in FIG. 3. In this example, the video game does not provide for interactive game play to move the avatar 201 from the edge of the cliff 203, across the river 205, to the pathway 301 into the forest 207. However, in some embodiments, it is desirable to have some filler content to somehow depict such movement of the avatar 201, so that when the recap of the video game play is generated, there is not an abrupt transition from the first video game output 101 (the end of the scene 200) to the second video game output 103 (the beginning of the scene 300). To this end, it is of interest for the developer of the video game to have a method and system for automatically generating the filler content for insertion in the content gap 105 between the first video game output 101 and the second video game output 103. Also, because the transition between the scene 200 depicted in FIG. 2 and the scene 300 depicted in FIG. 3 does not involve interactive play of the video game by the player, it is of interest to minimize the resources (financial and temporal) expended by the developer of the video game in generating the filler content for insertion in the content gap 105.

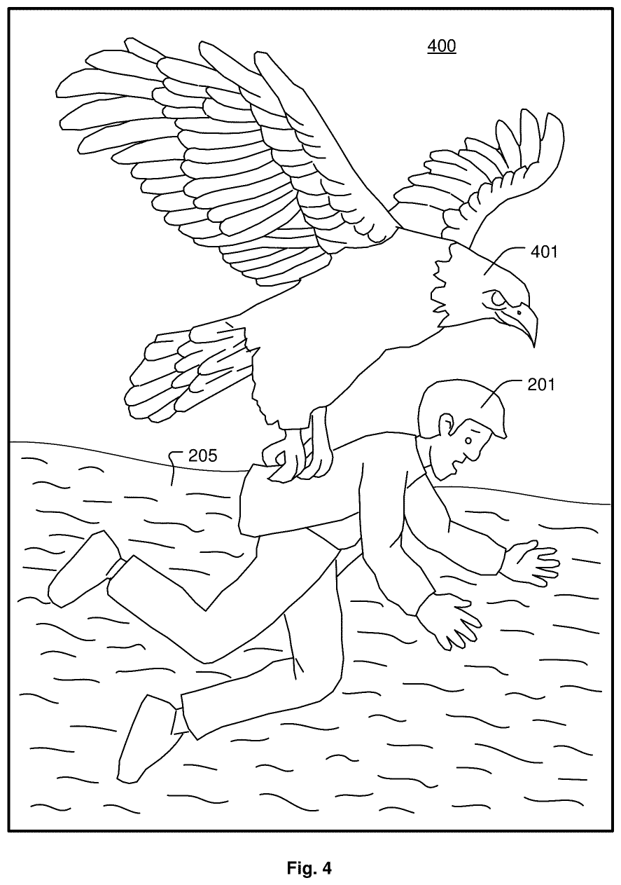

Methods and systems are disclosed herein for using AI to automatically generate filler content for insertion in the content gap 105 between the first video game output 101 and the second video game output 103. FIG. 4 shows an example image of a filler video clip that is automatically generated by the AI-based methods and systems disclosed herein as part of filler content for filling the content gap 105 between the scene 200 of FIG. 2 and the scene 300 of FIG. 3. More specifically, FIG. 4 shows a filler scene 400 within the video game in which the avatar 201 of the player is being carried by a bird 401 over the river 205. The filler video clip of the filler scene 400 is inserted between the first video game output 101 and the second video game output 103 to create a continuous recap of play of the video game that does not include the abrupt transition from the scene 200 to the scene 300 that is associated with the content gap 105. It should be appreciated that the AI-based methods and systems for generating the filler content for filling the content gap 105 are light-weight in regard to developer activity, thereby enabling substantial improvement in video game output without incurring the expense and time of having to expand the executional code of the video game. Also, because the filler content for filling the content gap 105 is generated by AI-based methods and systems, the filler content for filling the content gap 105 is subject to change each time it is generated, which can be leveraged to add a dynamic aspect to the recap of the video game play, which in turn enhances the video game player experience, which in turn leads to increased player engagement with the video game, which in turn leads to increased revenue for the video game developers and providers and the video game industry in general.

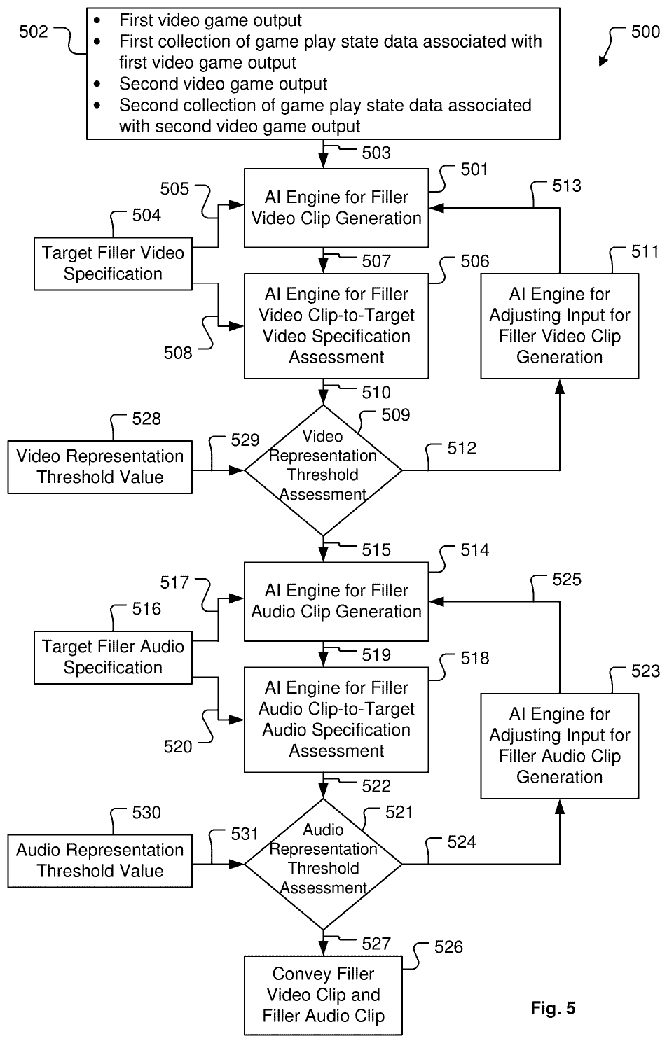

FIG. 5 shows a system 500 for automatically generating filler content for a video game, in accordance with some embodiments. FIG. 5 also depicts an operational flow between various components within the system 500. The system 500 includes a first AI engine 501 for filler video clip generation. In some embodiments, the first AI engine 501 is configured to automatically generate a filler video clip that fills a content gap between a first video game output and a second video game output. In some other embodiments, the first AI engine 501 is configured to automatically generate a filler video clip that fills a content gap after the first video game output, without having the second video game output. Also, in some other embodiments, the first AI engine 501 is configured to automatically generate a filler video clip that fills a content gap before the second video game output, without having the first video game output. The first AI engine 501 receives inputs 502, as indicated by arrow 503. In some embodiments, the inputs 502 include the first video game output, a first collection of game play state data associated with the first video game output, the second video game output, and a second collection of game play state data associated with the second video game output. In some embodiments, the inputs 502 include the first video game output and the first collection of game play state data associated with the first video game output, but do not include the second video game output and the second collection of game play state data associated with the second video game output. In some embodiments, the inputs 502 include the second video game output and the second collection of game play state data associated with the second video game output, but do not include the first video game output and the first collection of game play state data associated with the first video game output.

In some embodiments, the first AI engine 501 also receives a target filler video specification 504 as an additional input, as indicated by arrow 505. In some embodiments, the target filler video specification 504 includes a graphical feature specification that is to be represented in the filler video clip. In various embodiments, the graphical feature specification is a linguistic description of one or more of a graphical image, a graphical image movement, a graphical image transformation, a graphical image interaction, and any other characteristics of a graphical image that is linguistically describable. In some embodiments, a user interface (graphical user interface (GUI)) is provided to the user of the system 500 to enable the user to provide the target filler video specification 504. In some embodiments, the user interface includes one or more input tool(s), e.g., text box, microphone toggle, etc., by which the user is able to provide the linguistic description for the target filler video specification 504. Also, in some embodiments, the user interface for entry of the target filler video specification 504 provides one or more graphical control(s), e.g., slider bars, turnable knobs/dials, etc., by which the user is able to guide and/or customize the generation/content of the filler video clip. For example, in some embodiments, the user interface provides a slider bar that is incrementally (or smoothly) moveable from a first end representing a first condition associated with the filler video clip to a second end representing a second condition associated with the filler video clip. For example, in some embodiments, the first condition associated with the filler video clip is “less intense,” and the second condition associated with the filler video clip is “more intense.” In another example, the first condition associated with the filler video clip is “less epic,” and the second condition associated with the filler video clip is “more epic.” It should be understood that the type of conditional controls for generation of the filler video clip that can be made available to the user through the user interface is essentially limitless.

The first AI engine 501 is configured to automatically generate the filler video clip based on the first video game output, the first collection of game play state data associated with the first video game output, the second video game output, the second collection of game play state data associated with the second video game output, and the target filler video specification 504. The first AI engine 501 is trained to recognize the game contexts corresponding to each of the first video game output and the second video game output, so that the filler video clip generated by the first AI engine 501 is coherent in meaning and appearance with the game contexts of each of the first video game output and the second video game output. Also, in some embodiments, the system 500 provides for on-the-fly adjustment of the target filler video specification 504 by the user as the system 500 operates to generate the filler video clip.

In some embodiments, the first AI engine 501 is configured to generate the filler video clip independently of a game engine of the video game. More specifically, in some embodiments, the first AI engine 501 generates the filler video clip without engaging the game engine of the video game to generate game video for use in the filler video clip. In some embodiments, the system 500 implements AI prompt engineering to provide inputs to the first AI engine 501 for generating the filler video clip. In some embodiments, the filler video clip is generated to provide a coherent transition between the first video game output corresponding to the first game play state data and the second video game output corresponding to the second game play state data, so as to avoid abrupt content transitions within the filler video clip. By way of example, consider that the first video game output shows a character in a first boss fight, and the second video game output shows the character in a second boss fight. In this example, the first AI engine 501 generates the filler video clip to show the character moving from the end of the first boss fight to the beginning of the second boss fight. The system 500 operates to stitch together the first video game output, the filler video clip, and the second video game output to form a recap video, e.g., highlight reel, showing a substantially continuous representation of the character's actions without showing an abrupt change in scene, with minimal additional video game developer work.

In other embodiments, the first AI engine 501 is configured to engage the game engine of the video game for assistance in generating the filler video clip. More specifically, in some embodiments, the first AI engine 501 engages the game engine of the video game to generate game video for use in the filler video clip. In some of these embodiments, the first AI engine 501 is configured to generate filler game play state data for the content gap between the first video game output and the second video game output. In these embodiments, the system 500 is configured to provide the filler game play state data generated by the first AI engine 501 to the game engine of the video game, and direct execution of the game engine of the video game to generate the filler video clip based on the filler game play state data.

In some embodiments, the video game is a procedurally generated video game. In these embodiments, the system 500 is configured to generate filler code (executable program instructions) for the video game within the content gap between the first video game output and the second video game output. In these embodiments, the system 500 is configured to direct execution of the generated filler code for the video game to generate the filler video clip based on the filler game play state data. In these embodiments, the first AI engine 501 includes a first AI sub-engine configured to generate the filler code for the video game. Also, in these embodiments, the first AI engine 501 includes a second AI sub-engine configured to generate filler game play state data for the content gap between the first video game output and the second video game output, such that execution of the filler code for the video game in accordance with the filler game play state date provides for generation of the filler video clip. In some embodiments, the developer of the procedurally generated video game specifies story points through which the procedurally generated video game is required to proceed. In these embodiments, the system 500 is well-suited for use in automatically generating filler game content between the story points specified by the developer of the procedurally generated video game.

The system 500 also includes a second AI engine 506 configured to automatically determine a degree of representation of the target filler video specification 504 within the most recent instance of the filler video clip generated by the first AI engine 501. The second AI engine 506 receives the most recent instance of the filler video clip as generated by the first AI engine 501 as an input, as indicated by arrow 507. The second AI engine 506 also receives the target filler video specification 504 as an additional input, as indicated by arrow 508. The system 500 also includes a video representation threshold assessment module 509 configured to determine whether or not the degree of representation of the target filler video specification 504 within the most recent instance of the filler video clip, as determined by the second AI engine 506, satisfies a video representation threshold value 528. In some embodiments, the degree of representation of the target filler video specification 504 within the most recent instance of the filler video clip is specified by the second AI engine 506 on a fixed scale, e.g., a fixed scale of 0 to 100. In these embodiments, the video representation threshold value 528 is a developer-specified value along the fixed scale at or above which the degree of representation of the target filler video specification 504 within the most recent instance of the filler video clip is considered to be acceptable. The video representation threshold assessment module 509 is configured to receive the degree of representation of the target filler video specification 504 within the most recent instance of the filler video clip as determined by the second AI engine 506 as an input, as indicated by arrow 510. The video representation threshold assessment module 509 is also configured to receive the video representation threshold value 528 as an input, as indicated by arrow 529.

In some embodiments, the second AI engine 506 is configured to verify the coherency between the filler video clip generated by the first AI engine 501 and the video of the first video game output and/or the video of the second video game output. In these embodiments, the coherency between the filler video clip and video of the first video game output and/or the video of the second video game output can include any aspect of the video game play. For example, the coherency of the filler video clip can be verified with regard to character shape, character size, character appearance, character movements, scenes, contexts, graphical images, in-game objects, and/or essentially any other visual aspect of the video game output.

The system 500 also includes a third AI engine 511 configured to automatically generate a modified input for the first AI engine 501 that drives the most recent instance of the filler video clip as generated by the first AI engine 501 toward the target filler video specification 504. The third AI engine 511 is engaged, as indicated by arrow 512, when the video representation threshold assessment module 509 determines that the degree of representation of the target filler video specification 504 within the most recent instance of the filler video clip as generated by the first AI engine 501 is less than the video representation threshold value 528. The modified input for the first AI engine 501 is conveyed from the third AI engine 511 to the first AI engine 501, as indicated by arrow 513. The first AI engine 501, the second AI engine 506, the video representation threshold assessment module 509, and the third AI engine 511 are engaged in a repeating sequential manner until the video representation threshold assessment module 509 determines that the degree of representation of the target filler video specification 504 within the filler video clip is greater than or equal to the video representation threshold value 528. In some embodiments, the modified input for the first AI engine 501, as generated by the third AI engine 511, includes adjustments to which portions of the first collection of game play state data and/or the second collection of game play state data are used as inputs to the first AI engine 501 for generation of the next instance of the filler video clip.

The system 500 also includes a fourth AI engine 514 configured to automatically generate a filler audio clip that corresponds temporally and contextually with the most recent instance of the filler video clip as generated by the first AI engine 501. The fourth AI engine 514 is engaged, as indicated by arrow 515, when the video representation threshold assessment module 509 determines that the degree of representation of the target filler video specification 504 within the most recent instance of the filler video clip as generated by the first AI engine 501 is equal to or greater than the video representation threshold value 528. In some embodiments, the fourth AI engine 514 receives as input the first video game output, the first collection of game play state data associated with the first video game output, the second video game output, the second collection of game play state data associated with the second video game output, and the most recent instance of the filler video clip as generated by the first AI engine 501. In some embodiments, the inputs provided to fourth AI engine 514 include the first video game output and the first collection of game play state data associated with the first video game output, but do not include the second video game output and the second collection of game play state data associated with the second video game output. In some embodiments, the inputs provided to fourth AI engine 514 include the second video game output and the second collection of game play state data associated with the second video game output, but do not include the first video game output and the first collection of game play state data associated with the first video game output. In some embodiments, the first video game output includes a first audio clip, and the second video game output includes a second audio clip. In these embodiments, the fourth AI engine 514 is configured to generate the filler audio clip to extend from the first audio clip to the second audio clip, such that filler audio clip is contextually coherent with the first audio clip and the second audio clip.

Also, in some embodiments, the fourth AI engine 514 also receives a target filler audio specification 516 as an additional input, as indicated by arrow 517. In some embodiments, the target filler audio specification 516 includes an audio feature specification that is to be represented in the filler audio clip. In various embodiments, the audio feature specification is a linguistic description of one or more of an audio profile, a sound effect, an audio transformation, and any other characteristics of an audio clip that is linguistically describable. In some embodiments, the user interface for the system 500 enables the user to provide the target filler audio specification 516. In some embodiments, the user interface includes one or more input tool(s), e.g., text box, microphone toggle, etc., by which the user is able to provide the linguistic description for the target filler audio specification 516. Also, in some embodiments, the user interface for entry of the target filler audio specification 516 provides one or more graphical control(s), e.g., slider bars, turnable knobs/dials, etc., by which the user is able to guide and/or customize the generation/content of the filler audio clip. For example, in some embodiments, the user interface provides a slider bar that is incrementally (or smoothly) moveable from a first end representing a first condition associated with the filler audio clip to a second end representing a second condition associated with the filler audio clip. For example, in some embodiments, the first condition associated with the filler audio clip is “calm,” and the second condition associated with the filler audio clip is “chaotic.” In another example, the first condition associated with the filler audio clip is “less intense,” and the second condition associated with the filler audio clip is “more intense.” It should be understood that the type of conditional controls for generation of the filler audio clip that can be made available to the user through the user interface is essentially limitless.

The fourth AI engine 514 is configured to automatically generate the filler audio clip based on the first video game output, the first collection of game play state data associated with the first video game output, the second video game output, the second collection of game play state data associated with the second video game output, the most recent instance of the filler video clip as generated by the first AI engine 501, and the target filler audio specification 516. Also, in some embodiments, the system 500 provides for on-the-fly adjustment of the target filler audio specification 516 by the user as the system 500 operates to generate the filler audio clip.

In some embodiments, the fourth AI engine 514 is configured to generate the filler audio clip independently of a game engine of the video game. More specifically, in some embodiments, the fourth AI engine 514 generates the filler audio clip without engaging the game engine of the video game to generate game audio for use in the filler audio clip. In some embodiments, the system 500 implements AI prompt engineering to provide inputs to the fourth AI engine 514 for generating the filler audio clip. In some embodiments, the filler audio clip is generated to provide a coherent transition between the first video game output corresponding to the first game play state data and the second video game output corresponding to the second game play state data, so as to avoid abrupt content transitions within the filler audio clip.

By way of example, consider that the first video game output includes audio of calm sounds, and the second video game output includes audio of noisy sounds. In this example, the fourth AI engine 514 generates the filler audio clip to include audio that correlates with the filler video clip and that transitions coherently from the calm sounds of the first video game output into the noisy sounds of the second video game output. The system 500 operates to stitch together the audio of the first video game output, the filler audio clip, and the audio of the second video game output to form a recap audio clip, with minimal additional video game developer work.

In other embodiments, the fourth AI engine 514 is configured to engage the game engine of the video game for assistance in generating the filler audio clip. More specifically, in some embodiments, the fourth AI engine 514 engages the game engine of the video game to generate game audio for use in the filler audio clip. In some of these embodiments, the fourth AI engine 514 uses the filler game play state data generated by the first AI engine 501 in conjunction with the game engine of the video game to generate the filler audio clip based on the filler game play state data. Also, in some embodiments in which the system 500 is configured to generate filler code (executable program instructions) for the video game within the content gap between the first video game output and the second video game output, the system 500 is configured to direct execution of the generated filler code for the video game to generate the filler audio clip based on the filler game play state data.

The system 500 also includes a fifth AI engine 518 configured to automatically determine a degree of representation of the target filler audio specification 516 within the most recent instance of the filler audio clip generated by the fourth AI engine 514. The fifth AI engine 518 receives the most recent instance of the filler audio clip as generated by the fourth AI engine 514 as an input, as indicated by arrow 519. The fifth AI engine 518 also receives the target filler audio specification 516 as an additional input, as indicated by arrow 520. The system 500 also includes an audio representation threshold assessment module 521 configured to determine whether or not the degree of representation of the target filler audio specification 516 within the most recent instance of the filler audio clip, as determined by the fifth AI engine 518, satisfies an audio representation threshold value 530. In some embodiments, the degree of representation of the target filler audio specification 516 within the most recent instance of the filler audio clip is specified by the fifth AI engine 518 on a fixed scale, e.g., a fixed scale of 0 to 100. In these embodiments, the audio representation threshold value 530 is a developer-specified value along the fixed scale at or above which the degree of representation of the target filler audio specification 516 within the most recent instance of the filler audio clip is considered to be acceptable. The audio representation threshold assessment module 521 is configured to receive the degree of representation of the target filler audio specification 516 within the most recent instance of the filler audio clip as determined by the fifth AI engine 518 as an input, as indicated by arrow 522. The audio representation threshold assessment module 521 is also configured to receive the audio representation threshold value 530 as an input, as indicated by arrow 531.

In some embodiments, the fifth AI engine 518 is configured to verify the coherency between the filler audio clip generated by the fourth AI engine 514 and the audio of the first video game output and/or the audio of the second video game output. In these embodiments, the coherency between the filler audio clip and audio of the first video game output and/or the audio of the second video game output can include any aspect of the video game play. For example, the coherency of the filler audio clip can be verified with regard to character voices, character sounds, character movements, character interactions, ambient sounds, in-game object sounds, music, and/or essentially any other auditory aspect of the video game output.

The system 500 also includes a sixth AI engine 523 configured to automatically generate a modified input for the fourth AI engine 514 that drives the most recent instance of the filler audio clip as generated by the fourth AI engine 514 toward the target filler audio specification 516. The sixth AI engine 523 is engaged, as indicated by arrow 524, when the audio representation threshold assessment module 521 determines that the degree of representation of the target filler audio specification 516 within the most recent instance of the filler audio clip as generated by the fourth AI engine 514 is less than the audio representation threshold value 530. The modified input for the fourth AI engine 514 is conveyed from the sixth AI engine 523 to the fourth AI engine 514, as indicated by arrow 525. The fourth AI engine 514, the fifth AI engine 518, the audio representation threshold assessment module 521, and the sixth AI engine 523 are engaged in a repeating sequential manner until the audio representation threshold assessment module 521 determines that the degree of representation of the target filler audio specification 516 within the filler audio clip is greater than or equal to the audio representation threshold value 530. In some embodiments, the modified input for the fourth AI engine 514, as generated by the sixth AI engine 523, includes adjustments to which portions of the first collection of game play state data and/or the second collection of game play state data are used as inputs to the fourth AI engine 514 for generation of the next instance of the filler audio clip.

The system 500 also includes an output module 526 configured to convey the final instance of the filler video clip as generated by the first AI engine 501 and the final instance of the filler audio clip as generated by the fourth AI engine 514 as output of the system 500 for use by the developer of the video game. The output module 526 is engaged, as indicated by arrow 527, when the audio representation threshold assessment module 521 determines that the degree of representation of the target filler audio specification 516 within the most recent instance of the filler audio clip as generated by the fourth AI engine 514 is equal to or greater than the audio representation threshold value 530.

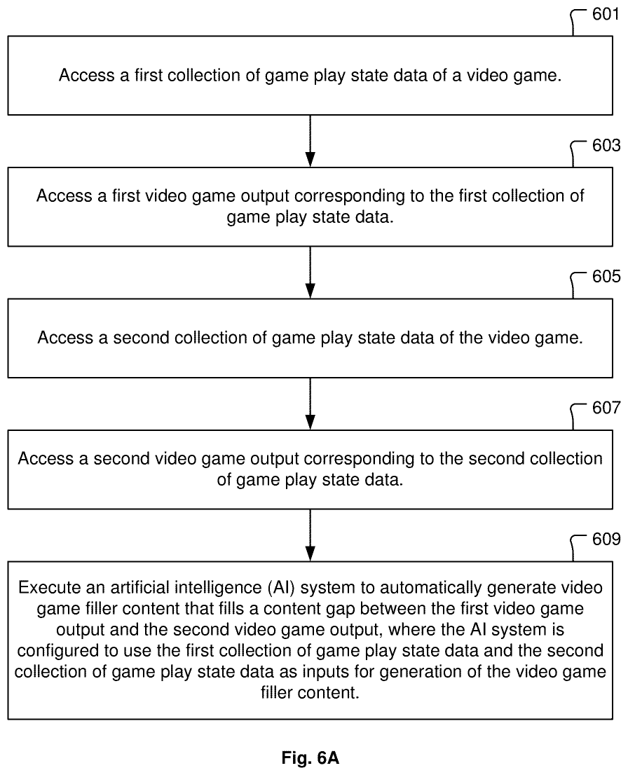

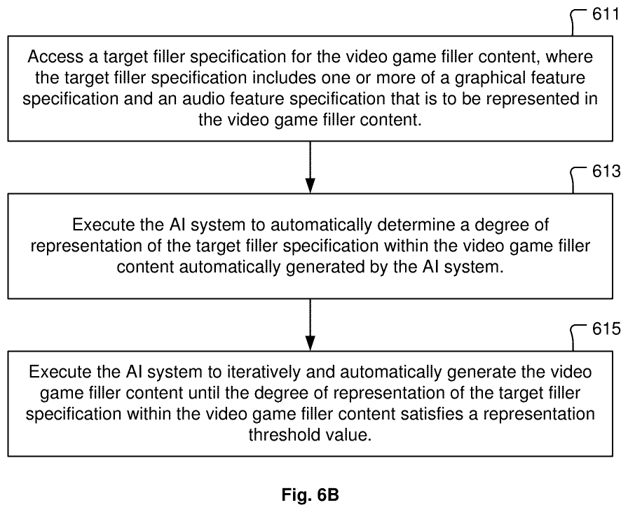

FIG. 6A shows a flowchart of a method for automatically generating filler content for a video game, in accordance with some embodiments. The method includes an operation 601 for accessing a first collection of game play state data of a video game. The method also includes an operation 603 for accessing a first video game output corresponding to the first collection of game play state data. The method also includes an operation 605 for accessing a second collection of game play state data of the video game. The method also includes an operation 607 for accessing a second video game output corresponding to the second collection of game play state data. The method includes an operation 609 for executing an AI system, e.g., system 500, to automatically generate video game filler content that fills a content gap between the first video game output and the second video game output. The AI system is configured to use the first collection of game play state data and the second collection of game play state data as inputs for generation of the video game filler content. In some embodiments, the first video game output includes a first video clip, the second video game output includes a second video clip, and the video game filler content includes a filler video clip that extends from the first video clip to the second video clip. In some embodiments, the first video game output includes a first audio clip, the second video game output includes a second audio clip, and the video game filler content includes a filler audio clip extending from the first audio clip to the second audio clip. In some embodiments, the method also includes inserting the video game filler content between the first video game output and the second video game output to create an enhanced video game output, and conveying the enhanced video game output to the player of the video game.

In some embodiments, operation 609 includes operating the AI system to generate the filler video clip independently of a game engine of the video game. In some embodiments, operation 609 includes operating the AI system to engage a game engine of the video game for generation of the filler video clip. In some embodiments, operation 609 includes operating the AI system to generate filler game play state data for the content gap between the first video game output and the second video game output, providing the filler game play state data to a game engine of the video game, and executing the game engine of the video game to generate the filler video clip based on the filler game play state data. In some embodiments, operation 609 includes operating the AI system to generate filler code for the video game within the content gap between the first video game output and the second video game output, and executing the filler code for the video game to generate the filler video clip based on the filler game play state data.

In some embodiments, the operation 609 includes operating the AI system to generate the filler audio clip independently of a game engine of the video game. In some embodiments, the operation 609 includes operating the AI system to engage a game engine of the video game for generation of the filler audio clip. In some embodiments, the operation 609 includes operating the AI system to generate filler game play state data for the content gap between the first video game output and the second video game output, providing the filler game play state data to a game engine of the video game, and executing the game engine of the video game to generate the filler audio clip based on the filler game play state data. In some embodiments, the operation 609 includes operating the AI system to generate filler code for the video game within the content gap between the first video game output and the second video game output, and executing the filler code for the video game to generate the filler audio clip based on the filler game play state data.

FIG. 6B shows a flowchart of an optional extension of the method of FIG. 6A, in accordance with some embodiments. The method includes an operation 611 for accessing a target filler specification for the video game filler content. The target filler specification includes one or more of a graphical feature specification and an audio feature specification that is to be represented in the video game filler content. The method also includes an operation 613 for executing the AI system to automatically determine a degree of representation of the target filler specification within the video game filler content automatically generated by the AI system. The method also includes an operation 615 for executing the AI system to iteratively and automatically generate the video game filler content until the degree of representation of the target filler specification within the video game filler content satisfies a representation threshold value.

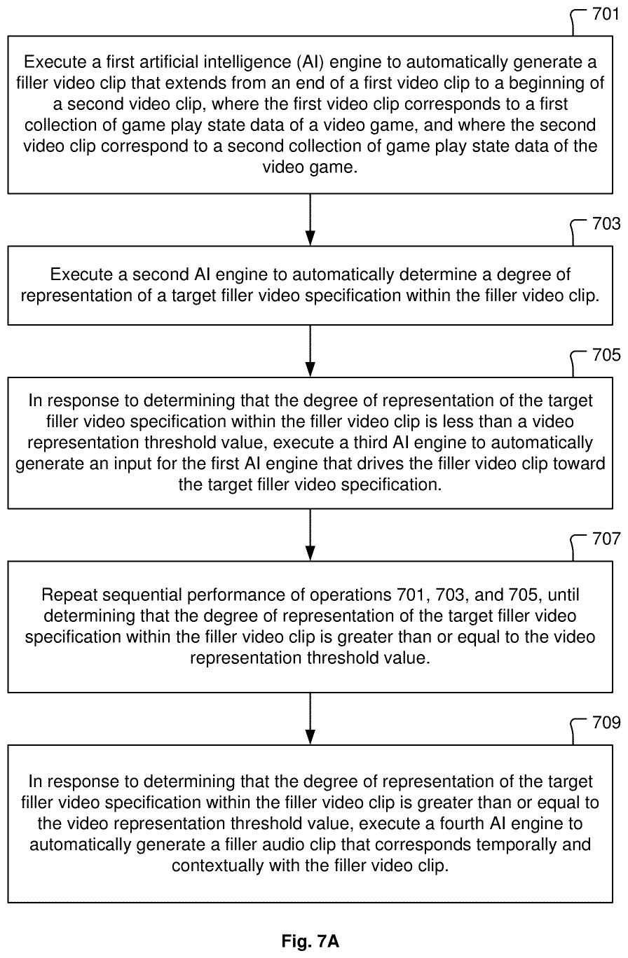

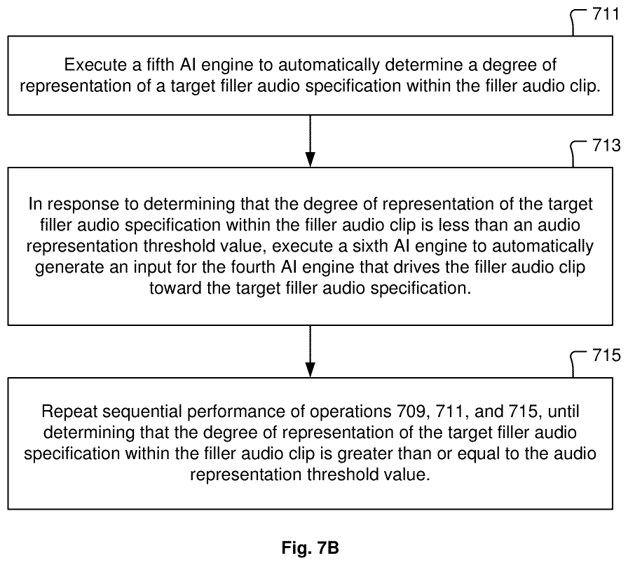

FIG. 7A shows a flowchart of a method for automatically generating filler content for a video game, in accordance with some embodiments. The method includes an operation 701 for executing a first AI engine to automatically generate a filler video clip that extends from an end of a first video clip to a beginning of a second video clip. The first video clip corresponds to a first collection of game play state data of a video game. The second video clip corresponds to a second collection of game play state data of the video game. In some embodiments, the first AI engine is configured to generate the filler video clip independently of a game engine of the video game. In some embodiments, the first AI engine is configured to engage a game engine of the video game for generation of the filler video clip. The method also includes an operation 703 for executing a second AI engine to automatically determine a degree of representation of a target filler video specification within the filler video clip. The method also includes an operation 705 that is performed in response to determining that the degree of representation of the target filler video specification within the filler video clip is less than a video representation threshold value, where the operation 705 includes executing a third AI engine to automatically generate an input for the first AI engine that drives the filler video clip toward the target filler video specification. The method also includes an operation 707 for repeating sequential performance of operations 701, 703, and 705, until it is determined in the operation 703 that the degree of representation of the target filler video specification within the filler video clip is greater than or equal to the video representation threshold value. The method also includes an operation 709 that is performed in response to determining that the degree of representation of the target filler video specification within the filler video clip is greater than or equal to the video representation threshold value, where the operation 709 includes executing a fourth AI engine to automatically generate a filler audio clip that corresponds temporally and contextually with the filler video clip.

In some embodiments, the method includes providing the first collection of game play state data, the second collection of game play state data, and the target filler video specification as inputs to the first AI engine for generation of the filler video clip. Also, in these embodiments, the method includes providing the first collection of game play state data, the second collection of game play state data, the target filler video specification, and the filler video clip as inputs to the fourth AI engine for generation of the filler audio clip. In some embodiments, the degree of representation of the target filler video specification within the filler video clip and the video representation threshold value are respective numerical values within a numerical range extending from a low value to a high value, where the low value indicates essentially zero representation of the target filler video specification within the filler video clip, and where the high value indicates substantially complete representation of the target filler video specification within the filler video clip.

FIG. 7B shows a flowchart of an optional extension of the method of FIG. 7A, in accordance with some embodiments. The method includes an operation 711 for executing a fifth AI engine to automatically determine a degree of representation of a target filler audio specification within the filler audio clip. The method also includes an operation 713 that is performed in response to determining that the degree of representation of the target filler audio specification within the filler audio clip is less than an audio representation threshold value, where the operation 713 includes executing a sixth AI engine to automatically generate an input for the fourth AI engine that drives the filler audio clip toward the target filler audio specification. The method also includes an operation 715 for repeating sequential performance of operations 709, 711, and 715, until it is determined that the degree of representation of the target filler audio specification within the filler audio clip is greater than or equal to the audio representation threshold value.

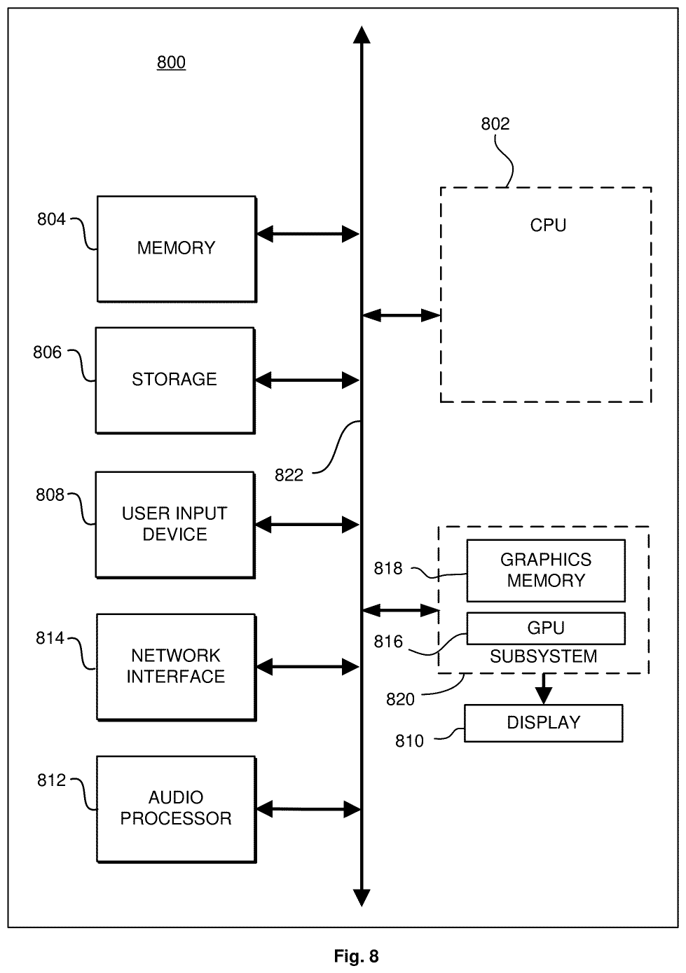

FIG. 8 shows various components of an example server device 800 within a cloud-based computing system that can be used to implement aspects of the system 500 of FIG. 5, and perform the methods of FIGS. 6A, 6B, 7A, and 7B, for AI-based generation of filler content for a video game, in accordance with some embodiments. This block diagram illustrates the server device 800 that can incorporate or can be a personal computer, video game console, personal digital assistant, a head mounted display (HMD), a wearable computing device, a laptop or desktop computing device, a server or any other digital computing device, suitable for practicing an embodiment of the disclosure. The server device (or simply referred to as “server” or “device”) 800 includes a central processing unit (CPU) 802 for running software applications and optionally an operating system. The CPU 802 may be comprised of one or more homogeneous or heterogeneous processing cores. For example, the CPU 802 is one or more general-purpose microprocessors having one or more processing cores. Further embodiments can be implemented using one or more CPUs with microprocessor architectures specifically adapted for highly parallel and computationally intensive applications, such as processing operations of interpreting a query, identifying contextually relevant resources, and implementing and rendering the contextually relevant resources in a video game immediately. Device 800 may be localized to a designer designing a game segment or remote from the designer (e.g., back-end server processor), or one of many servers using virtualization in the cloud-based gaming system 800 for remote use by designers.

Memory 804 stores applications and data for use by the CPU 802. Storage 806 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 808 communicate user inputs from one or more users to device 800, examples of which may include keyboards, mice, joysticks, touch pads, touch screens, still or video recorders/cameras, tracking devices for recognizing gestures, and/or microphones. Network interface 814 allows device 800 to communicate with other computer systems via an electronic communications network, and may include wired or wireless communication over local area networks and wide area networks such as the internet. An audio processor 812 is adapted to generate analog or digital audio output from instructions and/or data provided by the CPU 802, memory 804, and/or storage 806. The components of device 800, including CPU 802, memory 804, data storage 806, user input devices 808, network interface 814, and audio processor 812 are connected via one or more data buses 822.

A graphics subsystem 820 is further connected with data bus 822 and the components of the device 800. The graphics subsystem 820 includes a graphics processing unit (GPU) 816 and graphics memory 818. Graphics memory 818 includes a display memory (e.g., a frame buffer) used for storing pixel data for each pixel of an output image. Graphics memory 818 can be integrated in the same device as GPU 816, connected as a separate device with GPU 816, and/or implemented within memory 804. Pixel data can be provided to graphics memory 818 directly from the CPU 802. Alternatively, CPU 802 provides the GPU 816 with data and/or instructions defining the desired output images, from which the GPU 816 generates the pixel data of one or more output images. The data and/or instructions defining the desired output images can be stored in memory 804 and/or graphics memory 818. In an embodiment, the GPU 816 includes 3D rendering capabilities for generating pixel data for output images from instructions and data defining the geometry, lighting, shading, texturing, motion, and/or camera parameters for virtual object(s) within a scene. The GPU 816 can further include one or more programmable execution units capable of executing shader programs.

The graphics subsystem 820 periodically outputs pixel data for an image from graphics memory 818 to be displayed on display device 810. Display device 810 can be any device capable of displaying visual information in response to a signal from the device 800, including CRT, LCD, plasma, and OLED displays. In addition to display device 810, the pixel data can be projected onto a projection surface. Device 800 can provide the display device 810 with an analog or digital signal, for example.

Implementations of the present disclosure for the systems and methods for AI-based generation of video game filler content may be practiced using various computer device configurations including hand-held devices, microprocessor systems, microprocessor-based or programmable consumer electronics, minicomputers, mainframe computers, head-mounted display, wearable computing devices and the like. Embodiments of the present disclosure can also be practiced in distributed computing environments where tasks are performed by remote processing devices that are linked through a wire-based or wireless network.

With the above embodiments in mind, it should be understood that the disclosure can employ various computer-implemented operations involving data stored in computer systems. These operations are those requiring physical manipulation of physical quantities. Any of the operations described herein that form part of the disclosure are useful machine operations. The disclosure also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

Although various method operations were described in a particular order, it should be understood that other housekeeping operations may be performed in between the method operations. Also, method operations may be adjusted so that they occur at slightly different times or in parallel with each other. Also, method operations may be distributed in a system which allows the occurrence of the processing operations at various intervals associated with the processing.

One or more embodiments can also be fabricated as computer readable code (program instructions) on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices, or any other type of device that is capable of storing digital data. The computer readable medium can include computer readable tangible medium distributed over a network-coupled computer system so that the computer readable code is stored and executed in a distributed fashion.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

1. A method for automatically generating filler content for a video game, comprising:
accessing a first collection of game play state data of a video game;
accessing a first video game output corresponding to the first collection of game play state data;
accessing a second collection of game play state data of the video game;
accessing a second video game output corresponding to the second collection of game play state data; and
executing an artificial intelligence (AI) system to automatically generate video game filler content that fills a content gap between the first video game output and the second video game output, the AI system configured to use the first collection of game play state data and the second collection of game play state data as inputs for generation of the video game filler content.

2. The method as recited in claim 1, wherein the first video game output includes a first video clip, and wherein the second video game output includes a second video clip, and wherein the video game filler content includes a filler video clip that extends from the first video clip to the second video clip.

3. The method as recited in claim 1, wherein the AI system is configured to generate the filler video clip independently of a game engine of the video game.

4. The method as recited in claim 1, wherein the AI system is configured to engage a game engine of the video game for generation of the filler video clip.

5. The method as recited in claim 1, wherein the AI system is configured to generate filler game play state data for the content gap between the first video game output and the second video game output, wherein the method further includes providing the filler game play state data to a game engine of the video game and executing the game engine of the video game to generate the filler video clip based on the filler game play state data.

6. The method as recited in claim 5, wherein the AI system is configured to generate filler code for the video game within the content gap between the first video game output and the second video game output, wherein the method further includes executing the filler code for the video game to generate the filler video clip based on the filler game play state data.

7. The method as recited in claim 2, wherein the first video game output includes a first audio clip, and wherein the second video game output includes a second audio clip, and wherein the video game filler content includes a filler audio clip that extends from the first audio clip to the second audio clip, the filler audio clip temporally and contextually correlated with the filler video clip.

8. The method as recited in claim 7, wherein the AI system is configured to generate the filler audio clip independently of a game engine of the video game.

9. The method as recited in claim 7, wherein the AI system is configured to engage a game engine of the video game for generation of the filler audio clip.

10. The method as recited in claim 7, wherein the AI system is configured to generate filler game play state data for the content gap between the first video game output and the second video game output, wherein the method further includes providing the filler game play state data to a game engine of the video game and executing the game engine of the video game to generate the filler audio clip based on the filler game play state data.

11. The method as recited in claim 10, wherein the AI system is configured to generate filler code for the video game within the content gap between the first video game output and the second video game output, wherein the method further includes executing the filler code for the video game to generate the filler audio clip based on the filler game play state data.

12. The method as recited in claim 1, wherein the first video game output includes a first audio clip, and wherein the second video game output includes a second audio clip, and wherein the video game filler content includes a filler audio clip extending from the first audio clip to the second audio clip.

13. The method as recited in claim 1, further comprising:
accessing a target filler specification for the video game filler content, the target filler specification including one or more of a graphical feature specification and an audio feature specification that is to be represented in the video game filler content;
executing the AI system to automatically determine a degree of representation of the target filler specification within the video game filler content automatically generated by the AI system; and
executing the AI system to iteratively and automatically generate the video game filler content until the degree of representation of the target filler specification within the video game filler content satisfies a representation threshold value.

14. The method as recited in claim 1, further comprising:
inserting the video game filler content between the first video game output and the second video game output to create an enhanced video game output; and
conveying the enhanced video game output to the player of the video game.

15. A method for automatically generating filler content for a video game, comprising:
(a) executing a first artificial intelligence (AI) engine to automatically generate a filler video clip that extends from an end of a first video clip to a beginning of a second video clip, the first video clip corresponding to a first collection of game play state data of a video game, the second video clip corresponding to a second collection of game play state data of the video game;
(b) executing a second AI engine to automatically determine a degree of representation of a target filler video specification within the filler video clip;
(c) in response to determining that the degree of representation of the target filler video specification within the filler video clip is less than a video representation threshold value, executing a third AI engine to automatically generate an input for the first AI engine that drives the filler video clip toward the target filler video specification;
(d) repeating sequential performance of operations (a), (b), and (c) until determining that the degree of representation of the target filler video specification within the filler video clip is greater than or equal to the video representation threshold value; and
(e) in response to determining that the degree of representation of the target filler video specification within the filler video clip is greater than or equal to the video representation threshold value, executing a fourth AI engine to automatically generate a filler audio clip that corresponds temporally and contextually with the filler video clip.

16. The method as recited in claim 15, further comprising:
providing the first collection of game play state data, the second collection of game play state data, and the target filler video specification as inputs to the first AI engine for generation of the filler video clip; and
providing the first collection of game play state data, the second collection of game play state data, the target filler video specification, and the filler video clip as inputs to the fourth AI engine for generation of the filler audio clip.

17. The method as recited in claim 15, wherein the degree of representation of the target filler video specification within the filler video clip and the video representation threshold value are respective numerical values within a numerical range extending from a low value to a high value, wherein the low value indicates zero representation of the target filler video specification within the filler video clip, and wherein the high value indicates substantially complete representation of the target filler video specification within the filler video clip.

18. The method as recited in claim 15, further comprising:
(f) executing a fifth AI engine to automatically determine a degree of representation of a target filler audio specification within the filler audio clip;
(g) in response to determining that the degree of representation of the target filler audio specification within the filler audio clip is less than an audio representation threshold value, executing a sixth AI engine to automatically generate an input for the fourth AI engine that drives the filler audio clip toward the target filler audio specification; and
(h) repeating sequential performance of operations (e), (f), and (g) until determining that the degree of representation of the target filler audio specification within the filler audio clip is greater than or equal to the audio representation threshold value.

19. The method as recited in claim 15, wherein the first AI engine is configured to generate the filler video clip independently of a game engine of the video game.

20. The method as recited in claim 15, wherein the first AI engine is configured to engage a game engine of the video game for generation of the filler video clip.
